(19) United States
(12) Patent Application Publication
(10) Pub. No.: US 2023/0290283 A1
(43) Pub. Date: Sep. 14, 2023

(54) TRAILER HITCH BALL ACCESSORY PLATFORM

(71) Applicant: Juggernaut Tactical, Inc., Orange, CA (US)

(72) Inventor: Zackary Kasanjian-King, Corona, CA (US)

(73) Assignee: Juggernaut Tactical, Inc., Orange, CA (US)

(21) Appl. No.: 18/119,546

(22) Filed: Mar. 9, 2023

Related U.S. Application Data
(60) Provisional application No. 63/318,908, filed on Mar. 11, 2022.

(51) Int. Cl. G09F 17/00

(52) U.S. Cl. CPC G09F 17/00; G09F 2017/0075

(57) ABSTRACT

A support for a vehicle accessory flagpole comprises a ball hitch element having a receiver interface. The ball has a plurality of flat facets; a pole support having a flat bottom surface; and a clamp operably connected to the pole support and the ball to bias the flat bottom surface against one of the facets.

### CROSS-REFERENCE TO RELATED APPLICATIONS

This application claims the benefit of U.S. Provisional Patent Application No. 63/318,908, filed on Mar. 11, 2022, entitled “TRAILER HITCH BALL ACCESSORY PLATFORM”, which is hereby incorporated by reference in its entirety for all that is taught and disclosed therein.

### FIELD OF THE INVENTION

The present invention relates to trailer hitches.

### BACKGROUND AND SUMMARY

Traditional vehicle accessory hitches do not allow for multiple interfaces.

The above disadvantage is addressed by a support for a vehicle accessory flagpole that comprises a ball hitch element having a receiver interface. The ball has a plurality of flat facets; a pole support having a flat bottom surface; and a clamp operably connected to the pole support and the ball to bias the flat bottom surface against one of the facets.

### BRIEF DESCRIPTION OF THE DRAWINGS

FIG. 1 is a view of the device attached to a standard trailer hitch ball.

FIG. 2 is a closeup view of the device attached to a standard trailer hitch ball.

FIG. 3 shows the device mounted to a gooseneck ball.

FIG. 4 shows the device mounted to a gooseneck ball.

FIG. 5 shows the device's ability pivot around the ball and securely attach at an arbitrary angle.

FIG. 6 shows the device's ability pivot around the ball and securely attach at an arbitrary angle.

FIG. 7 shows the main components.

FIG. 8 is a trailer hitch ball.

FIG. 9 is a cross-sectional view.

FIG. 10 shows the Collar in the unlocked position.

FIG. 11 shows a flat Tension Pad inserted into the threaded end portion of the Tensioning Handle.

FIGS. 12-21 are photographs of the components of the functioning prototype shown in FIGS. 1-6.

FIG. 22 is a bottom view.

FIG. 23 is a top view.

FIG. 24 is a view without collar.

FIG. 25 is a view of an option of a customized hitch ball with several flat areas.

### DETAILED DESCRIPTION OF A PREFERRED EMBODIMENT

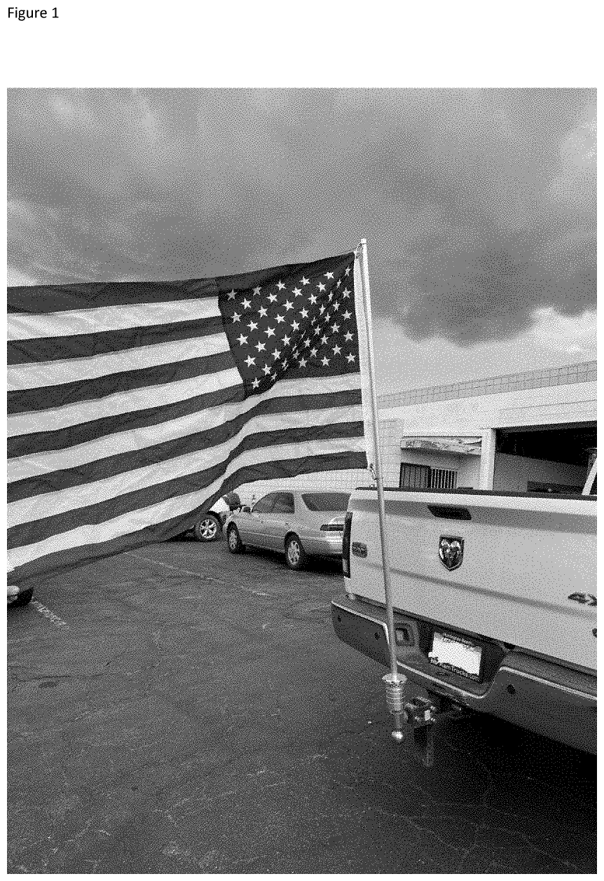

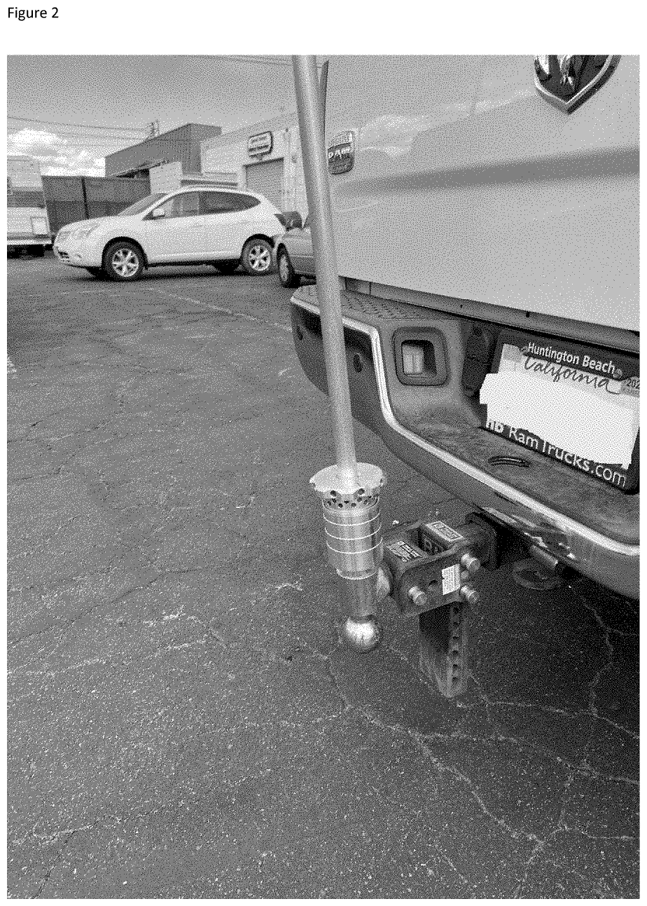

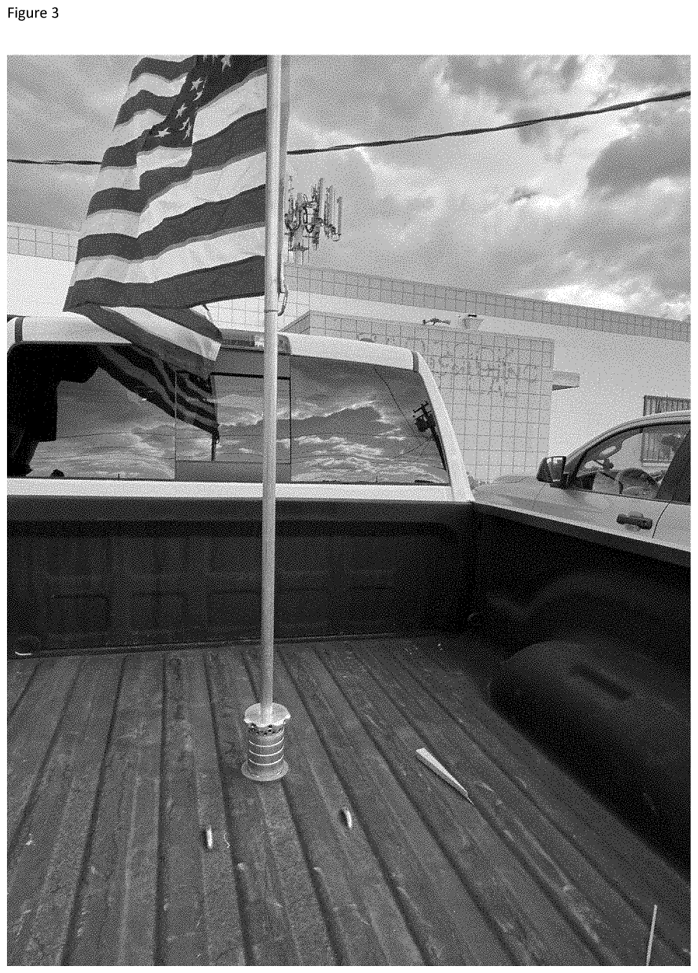

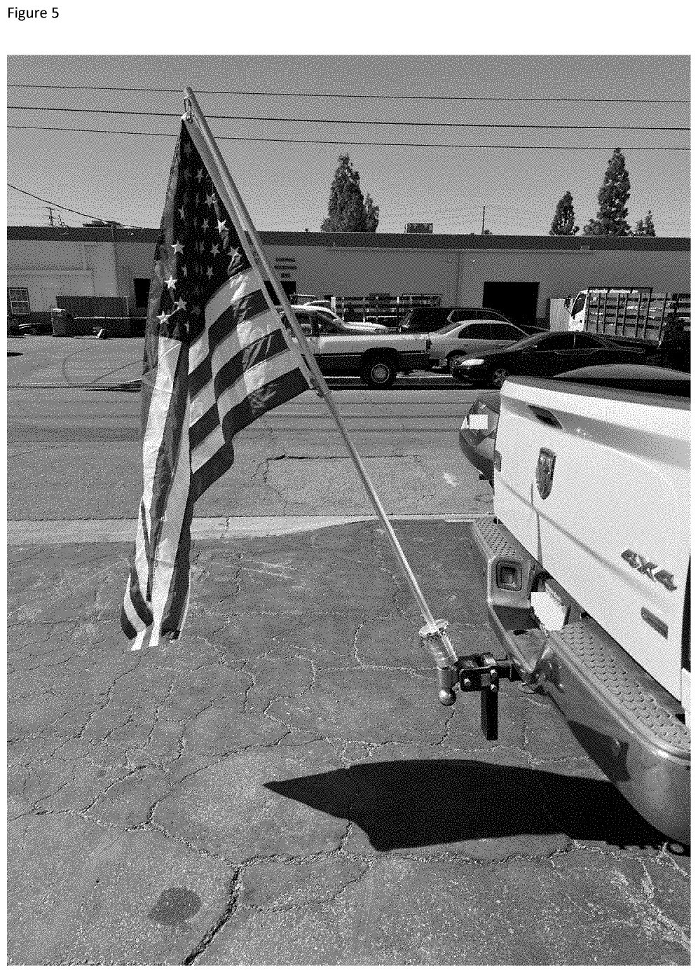

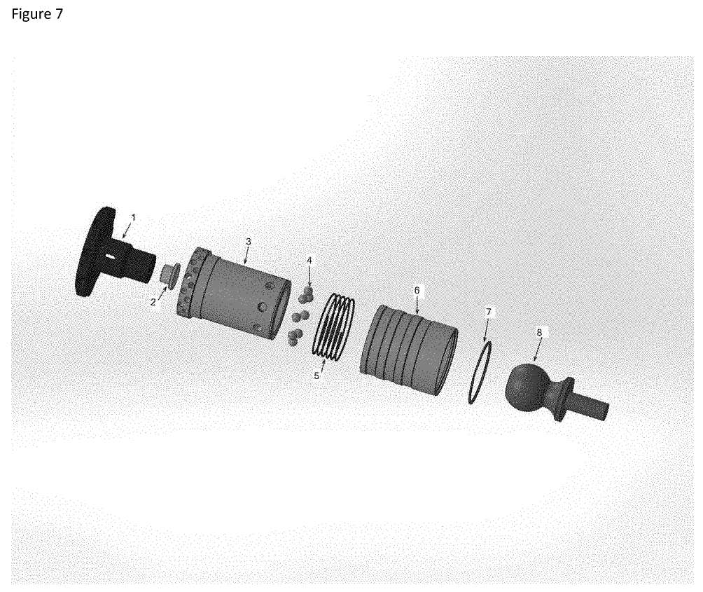

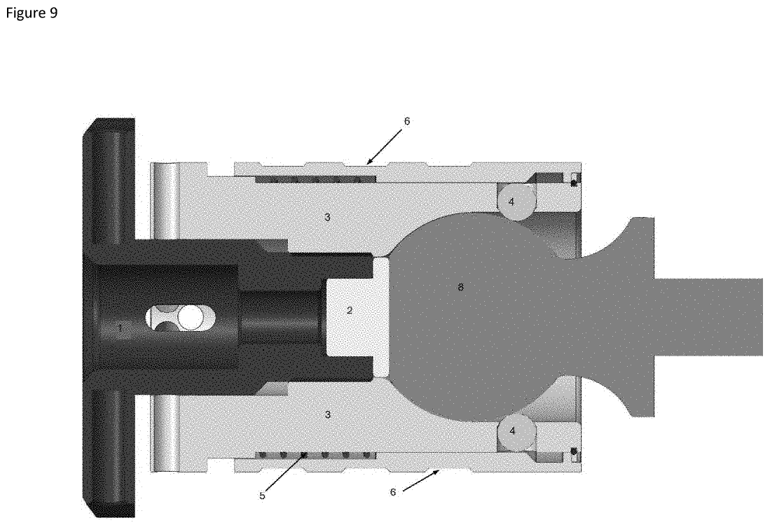

FIG. 1 shows the device attached to a standard trailer hitch ball and FIG. 2 is a closeup view. The hole in the center is used to attach an accessory, in this case the flagpole. The smaller holes on the side will accept locking pins, also used to securely attach the accessory. One version of a standard towing ball has a flat top as shown in FIGS. 7-#8 and 8-#8. A second version is rounded as shown in FIG. 9-#8 and is typically named a gooseneck hitch and is mounted in the bed of a pickup truck. FIGS. 3 & 4 show the device mounted to a gooseneck ball. Another important aspect of the device allows it to pivot around the ball and securely attach at an arbitrary angle as shown in FIGS. 5 & 6.

The main components are shown in FIG. 7. It consists of the Tensioning Handle 1, Tension Pad 2, Main Housing 3, Locking Elements 4, Collar Spring 5, Collar 6, and Collar Retaining Ring 7. Also shown is a Trailer Hitch Ball 8.

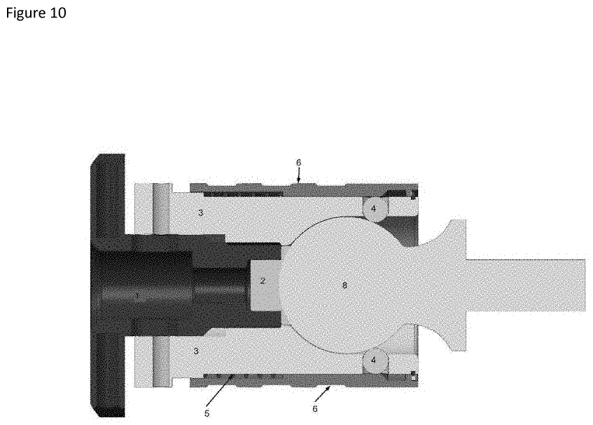

The Collar 6 fits over the Main Housing 3 and can slide on the Main Housing to engage and disengage the Locking Elements 4. In this example the Locking Elements are Ball Bearings. FIG. 9 is a cross-sectional view showing the Collar (green), Main Housing, and Ball Bearings with the Collar in the normally locked configuration due to the force of the Spring 5. In the locked configuration, the Collar 6 prevents the ball bearings from moving beyond the outside edge of the Main Housing 3. The Collar 6 has an interior cavity to accept the ball bearings when the Collar is in the unlocked position. FIG. 10 shows the Collar in the unlocked position where the ball bearings are in the cavity, away from the Trailer Hitch Ball 8, allowing the device to be detached from the Trailer Hitch Ball.

Installing and removing is quick and easy to do. To install, simply pull back the Collar against the tension of the spring and place the device over the hitch ball and release the Collar. Then rotate the Tensioning Handle by hand to securely tighten the device to the hitch ball. Removing the device requires one or two rotations of the Tensioning Handle followed by grabbing the Collar and pulling toward the Tensioning Handle which allows removing the device from the hitch ball.

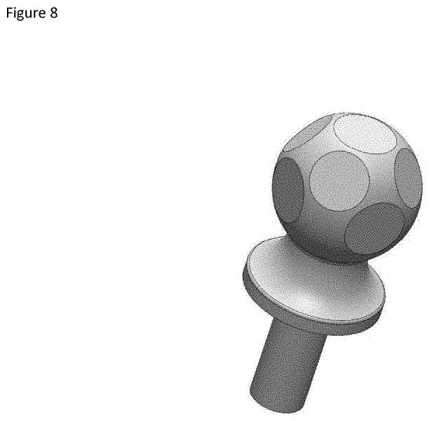

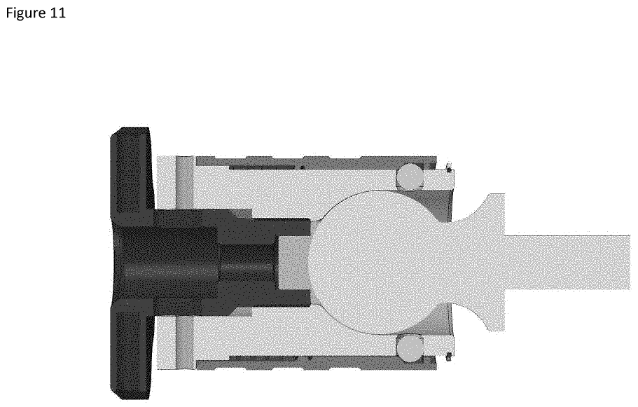

The Tension Pad 2 fits inside of the threaded portion of the Tensioning Handle 1 and extends beyond the end of the threads. The Tension Pad shape exactly matches the shape of the hitch ball. FIG. 8 shows a flat Tension Pad while FIG. 9 shows a curved pad matched to the radius of the hitch ball. FIG. 11 shows a flat Tension Pad inserted into the threaded end portion of the Tensioning Handle.

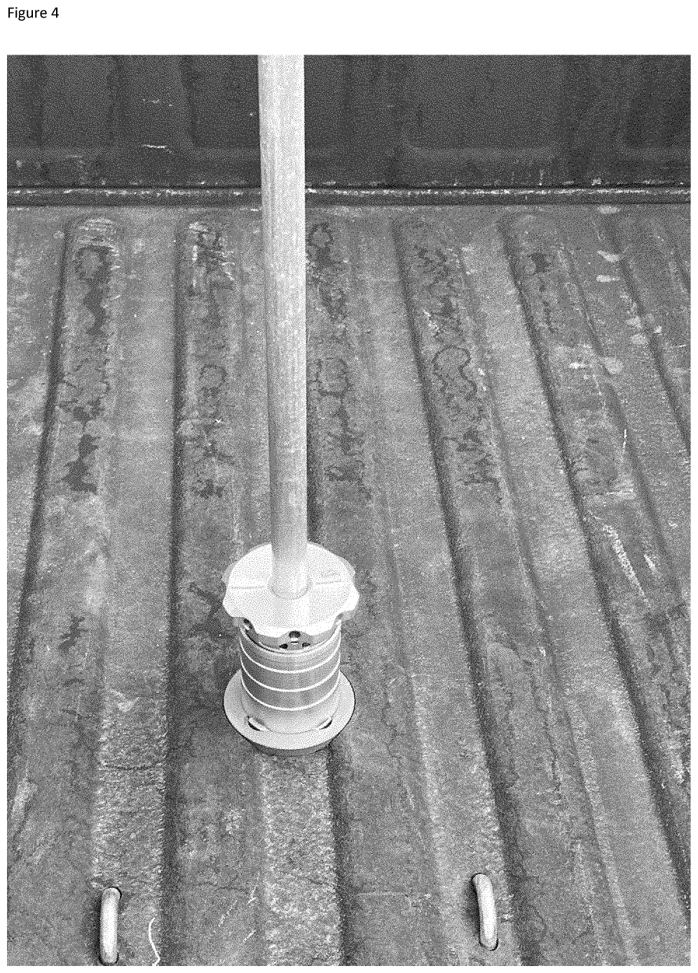

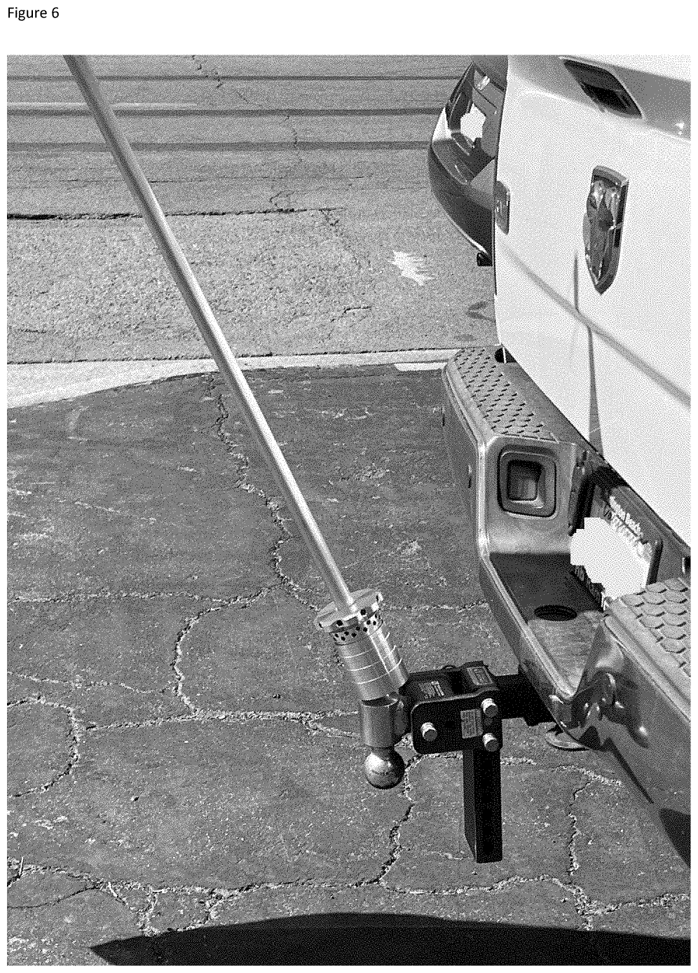

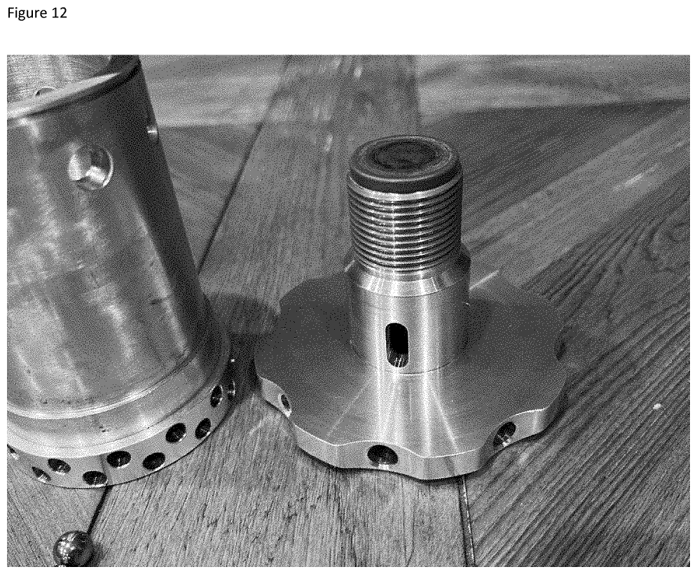

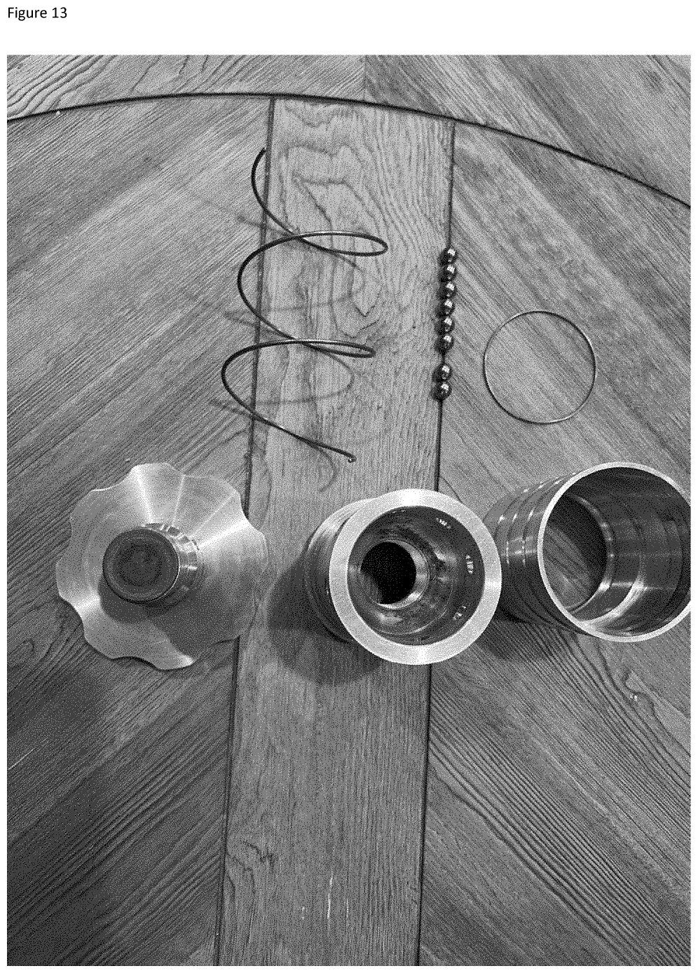

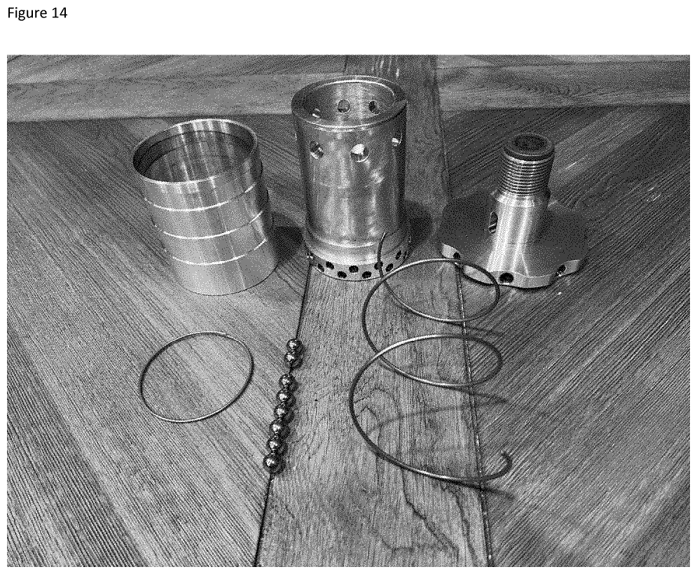

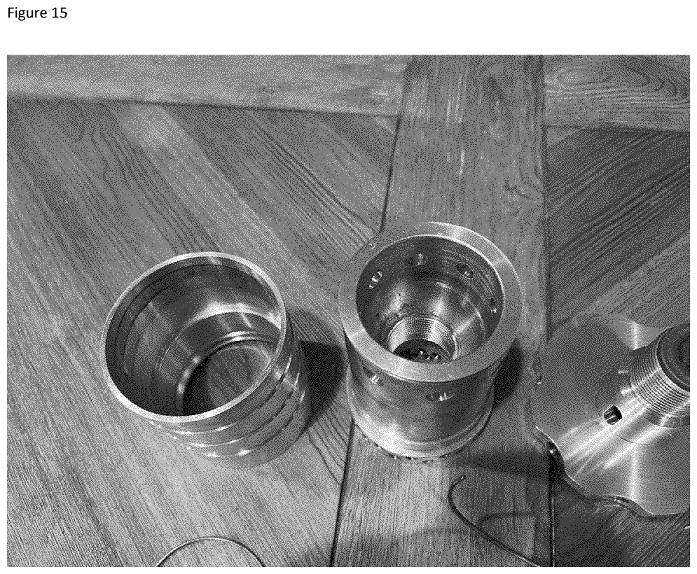

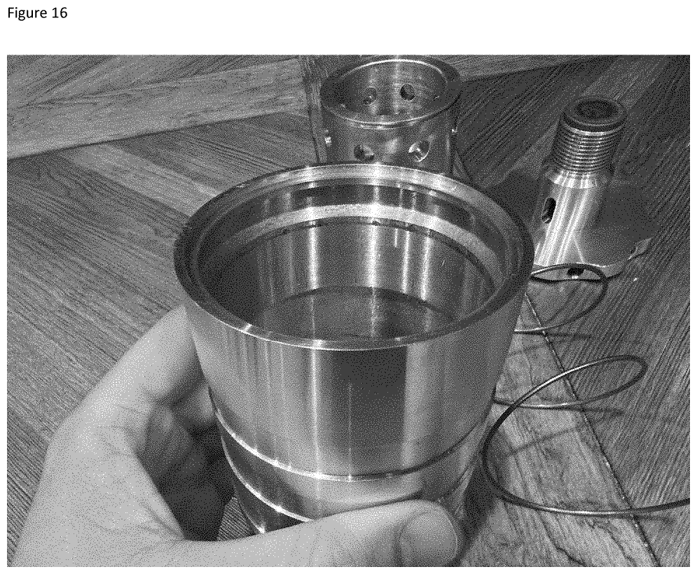

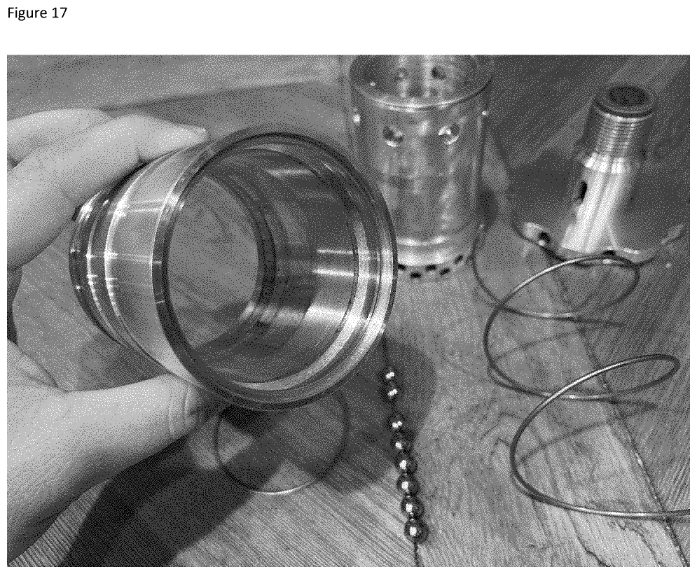

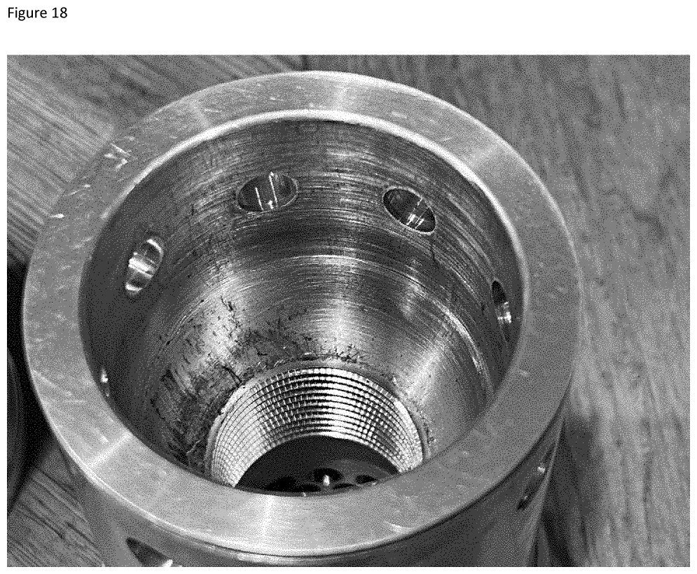

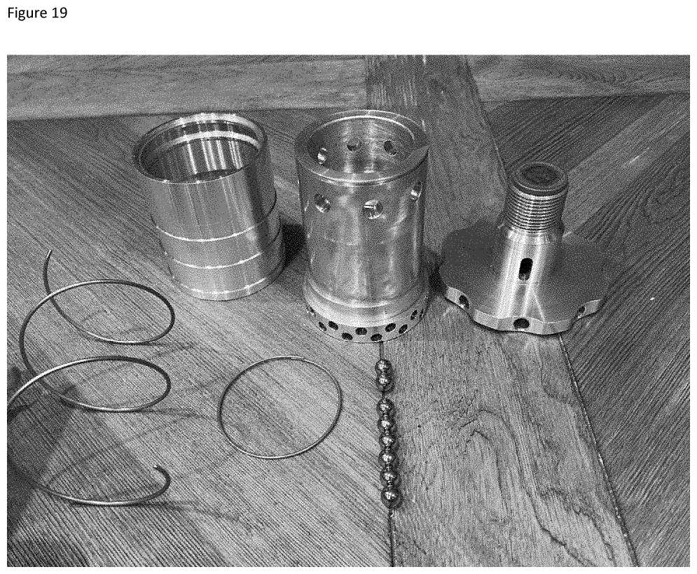

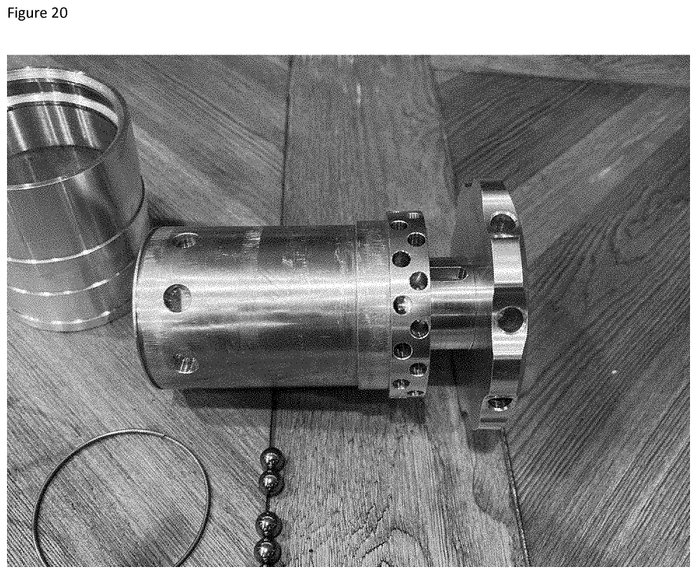

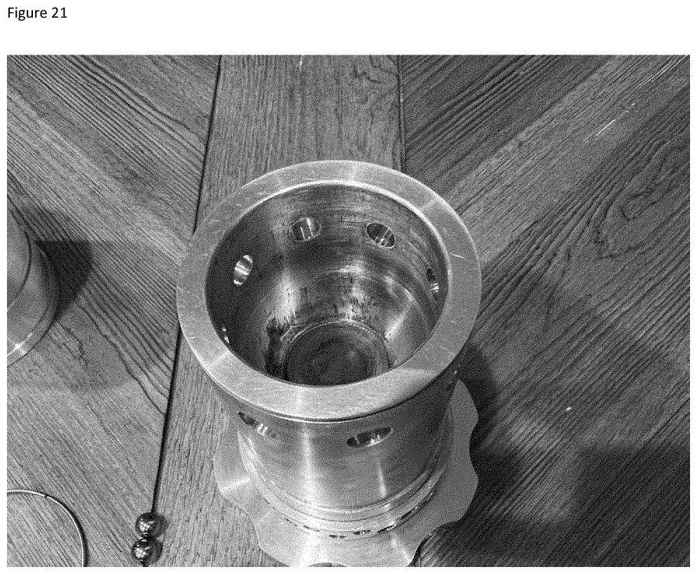

As mentioned above, this device is not limited to a platform for a flagpole. The large center hole of the Tensioning Handle along with the perpendicular smaller holes around the edge of the handle and housing can be used to attach an accessory with locking pins. FIGS. 11-21 are photographs of the components of the functioning prototype shown in FIGS. 1-6.

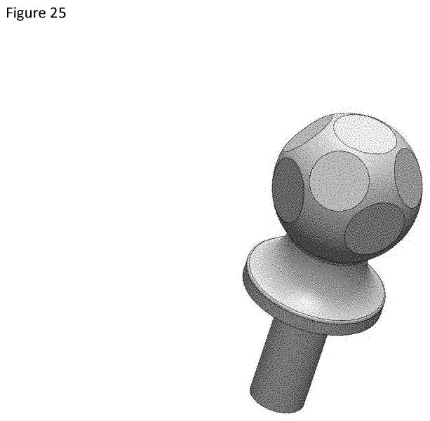

This device may also include a standard sized trailer hitch ball with grooves and/or holes that are configured to be more compatible with the use case of an accessory. For example, a workbench to securely hold material for a router may need to be pivoted to angles of 15, 30, or 45 degrees. Channels to accept the locking elements can be cut all the way around the hitch ball at specific angles. Another option would be to create a customized hitch ball with several flat areas as shown in FIG. 25.

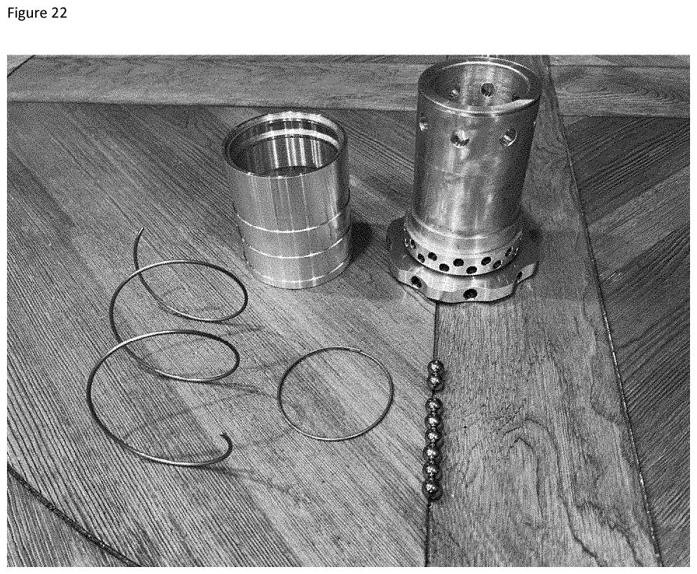

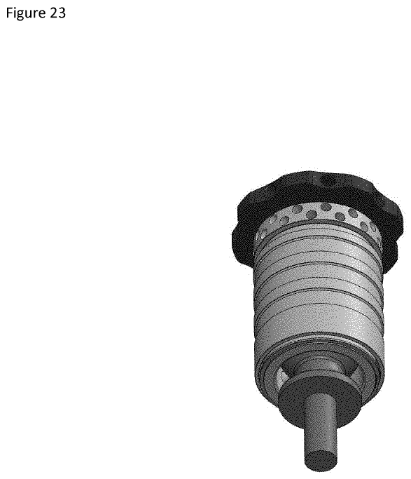

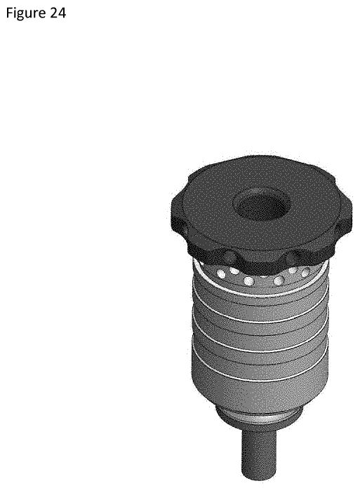

Additional figures are included which give the following views: Bottom View FIG. 22, Top View FIG. 23, Without Collar FIG. 24.

I claim:

1. A support for a vehicle accessory flagpole comprising:
a ball hitch element having a receiver interface;
the ball having a plurality of flat facets;
a pole support having a flat bottom surface; and
a clamp operably connected to the pole support and the ball to bias the flat bottom surface against one of the facets.
